(19) United States
(12) Patent Application Publication
(10) Pub. No.: US 2009/0262069 A1
(43) Pub. Date: Oct. 22, 2009

(54) GESTURE SIGNATURES

(75) Inventor: Matthew Huntington, Twickenham (GB)

Correspondence Address: SCHWEGMAN, LUNDBERG & WOESSNER/OPEN TV, P.O. BOX 2938, MINNEAPOLIS, MN, 55402-0938, US

(73) Assignee: OpenTV, Inc., San Francisco, CA (US)

(21) Appl. No.: 12/107,388

(22) Filed: Apr. 22, 2008

(51) Int. Cl. G09G 5/00

(52) U.S. Cl. 345/156

(57) ABSTRACT

Apparatus, systems, and methods may operate to present viewable content to a viewer on a display screen, receive a transmitted signature from a user interface device (UID) associated with the display screen (wherein the signature results from at least one gesture initiated by the viewer and detected by the UID), and compare the transmitted signature to a stored signature associated with a known individual to determine whether an identity associated with the viewer matches an identity associated with the known individual. Additional apparatus, systems, and methods are disclosed.

### BACKGROUND

In the field of television entertainment, the sheer volume of content that is available for viewing is rising dramatically. Just the number of television channels that are now available is almost unmanageable. The amount of content that is available via video on demand service is also increasing. Further, it is now possible to view content over a wider span of time by employing time shifting technologies, such as Personal Video Recording (PVR), sometimes also referred to as Digital Video Recording (DVR).

This explosion of content gives rise to issues concerning access to the content. First, how to narrow the range of selection by providing viewers with content that suits their own personal taste. Second, how to narrow the selection range by controlling the potential for access to inappropriate content, such as confidential information.

### BRIEF DESCRIPTION OF DRAWINGS

Embodiments are illustrated by way of example and not limitation in the figures of the accompanying drawings, in which like references indicate similar elements and in which:

FIG. 1 is a block diagram of apparatus and systems according to various embodiments of the invention.

FIGS. 2 and 3 are flow diagrams illustrating methods according to various embodiments of the invention.

FIG. 4 is a block diagram of a machine in the example form of a computer system within which a set of instructions, to cause the machine to perform any one or more of the methodologies discussed herein, may be stored and/or executed.

### DETAILED DESCRIPTION

To address some of the challenges described above, among others, the inventor has discovered a mechanism that makes use of motion gestures, captured by a motion sensor to create a signature identifying viewers attempting to access communication content. Some embodiments go beyond identifying viewers, to assisting in viewer authentication—proving identified viewers are who they say they are. For example, authentication is useful in the case of parental control access, to help ensure under-age viewers are not able to view inappropriate material. Another example involves access to confidential information.

For the purposes of this document, the following terms are defined:

“Authentication” is a secure process that ensures a viewer is who he or she claims to be. Authentication permits access rights to be established in some embodiments.

A “gesture” is a substantially repeatable pattern of movement executed by a human being interacting with a user interface device (UID), perhaps manipulating the UID or gesticulating in a manner that is detected by the UID. Gestures can be implemented in two and/or three dimensions.

“Identification” is a process of comparing a received signature against database reference signatures, so that when a match is obtained, the access rights of the viewer attempting to access viewable content may be established in some embodiments. Thus, it is possible to establish access rights based solely on identification. However, in some embodiments, both identification and authentication are used to establish access rights. This can occur, for example, as part of a process that is similar to what is used when accessing a bank account via an automated teller machine, where a credit card is used for identification, and a personal identification number (PIN) is used for authentication. In some embodiments, then, signature comparison can be used for identification, and the entry of viewer-specific data (e.g., a PIN) can be used for authentication.

A “signature” is an electronic representation of a gesture that is provided by the UID.

The term “transceiver” (e.g., a communications device including a transmitter and a receiver) may be used in place of either “transmitter” or “receiver” throughout this document. Thus, anywhere the term transceiver is used, “transmitter” and/or “receiver” may be substituted, depending on the functions that are used.

A “user interface device” or “UID” may comprise a wand, a joystick, a track ball, a single touch surface (e.g., track pad), a multi-touch surface, an infra-red sensor, an acoustic sensor, a laser sensor, a radar sensor (e.g., Doppler effect), a camera, one or more photocells, and/or one or more switches. The UID operates as a “control” when it sends commands to affect the display of viewable content.

The use of gestures for identification and authentication may have several advantages over more conventional methods. For example, the text entered for usernames and passwords is typically limited by the keys available on a remote control. This kind of data entry can interfere with viewing enjoyment, especially when it operates to obscure a substantial portion of the available viewing area. Gestures can be used to overcome some of these limitations. Further, gesture-based identification lends itself to tailored viewer interfaces, with choices based on past activity, such as recommendations, offers, and promotions, including targeted advertisements.

In recent years new user interfaces have emerged that are controlled through user motion, including s accelerometer-based wands (e.g., such as the wand used to control the Nintendo™ Wii™ video game console). These controls can capture three-dimensional (3D) motion that occurs in free space, including gestures used for identification and authentication. Track pads can be used in a similar way, capturing finger movement in a plane. For example, track pads can operate as a cursor movement interface to laptop computers, replacing a computer mouse to move a cursor around a screen. More sophisticated touch surface interfaces are available that can track multi-finger movement. Cameras and other visible motion sensors can also be used to capture gestures from viewers.

In some embodiments, viewers can draw shapes in the air. In this way, each viewer can be identified by a characteristic shape, or series of shapes. This permits identification in a less intrusive manner than might occur with more traditional processes, such as selecting a name from a list displayed in conjunction with viewable content.

The UID used to detect gestures can be monitored on a substantially constant basis, so that gestures can be recognized as they occur. Thus, recognition can occur without prompting by the system (e.g., perhaps initiated by a user attempting to access viewable content), or in response to a prompt for gestures associated with viewer identification.

When commerce transactions and other sensitive operations are involved, including parental control, messaging services, and setting profile preferences, viewer authentication may be desired. In such embodiments, additional gestures may be recognized. For example, a set of standard gestures (e.g., circle, triangle, line) might be used for basic identification, and custom-designed gestures (e.g., a single complex gesture that emulates a written signature executed in space) might be used for authentication. In some embodiments, a sequence of gestures (e.g., a triangle, then a square, and then a star) might be used as a personal identification number (PIN) number. Any combination that is unique to a user can be used for authentication. Unlike signature pads used with conventional point-of-sale (POS) terminals, the gestures detected are not simply stored—they are inspected in substantially real time. Thus, many embodiments may be realized.

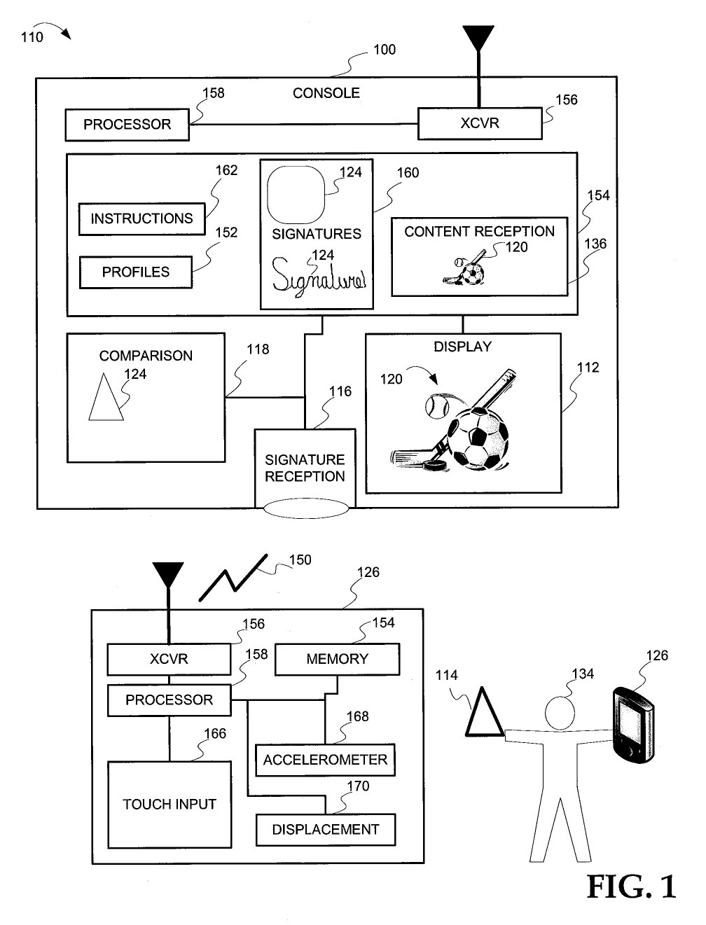

For example, FIG. 1 is a block diagram of apparatus 100 and systems 110 according to various embodiments of the invention. For example, an apparatus 100 (e.g., a television or other entertainment console) used to identify a viewer 134 according to some embodiments comprises a content reception module 136 to receive viewable content 120, and a display screen 112 to display the viewable content 120.

The apparatus 100 may include a signature reception module 116 to receive a transmitted signature 150 resulting from at least one gesture 114 initiated by the viewer 134 and detected by a UID 126 associated with the display screen 112. The apparatus 100 may also include a comparison module 118 to compare the transmitted signature 150 with one or more stored signatures 124 associated with a known individual to determine whether an identity associated with the viewer 134 matches an identity associated with the known individual.

The content 120 available for viewing may include television programming, locally stored content, video on demand, content available on a local network, as well as content accessible via the Internet. The delivery mechanism for viewable content 120 may be a satellite, cable, the Internet, local storage, a local network, mobile telephony, combinations thereof, and any other content distribution network.

In some embodiments, the apparatus 100 may comprise a storage module 154 to store a plurality of user signatures 124 (e.g., in signature storage 160) and a corresponding plurality of user profiles 152. The storage module 154 may comprise disk storage, flash memory, and other types of memory used to keep signatures 124 and profiles 152 organized for rapid recall. Still other embodiments may be realized.

For example, a system 110 may include one or more apparatus 100 and one or more UIDs 126 to control the display screen 112 and to transmit a transmitted signature 150 resulting from at least one gesture 114 initiated by the viewer 134 and detected by the UID 126.

In some embodiments, the UID 126 comprises a remote control wand having at least one accelerometer 168. The UID may also comprise a touch surface 166, perhaps forming part of the display screen 112. That is, the UID 126 may be located apart form the apparatus 100 (as shown in FIG. 1), or formed as an integral part of the apparatus 100. The display screen 112 may comprise a television screen. Thus, the apparatus 100 may comprise a computer, television, and/or coffee table with a built in display, for example. A system 110 may comprise a table having a built-in display that includes a multi-touch surface 166. The UID 126 may also comprise a body displacement sensor 170, such as a photocell, radar sensor, camera, laser, etc.

Both the apparatus 100 and system 110 may include one or more processors 158 used to access and execute instructions 162 stored in the memory 154. The apparatus 100 and UID 126 may include one or more wireless transceivers 156 to communicate with each other and with other devices, such as routers and access points coupled to one or more networks.

Any of the components previously described can be implemented in a number of ways, including simulation via software. Thus, the apparatus 100, systems 110, display screen 112, gesture 114, signature reception module 116, comparison module 118, viewable content 120, signatures 124, UIDs 126, viewer 134, content reception module 136, transmitted signature 150, profiles 152, storage module 154, wireless transceivers 156, processors 158, signature storage 160, instructions 162, touch surface 166, accelerometer 168, and body displacement sensor 170 may all be characterized as “modules” herein.

Such modules may include hardware circuitry, single and/or multi-processor circuits, memory circuits, software program modules and objects, and/or firmware, and combinations thereof, as desired by the architect of the apparatus 100 and systems 110, and as appropriate for particular implementations of various embodiments. For example, such modules may be included in an operation simulation package, such as a software electrical signal simulation package, a signature propagation simulation package, a network host simulation package, a network advertising simulation package, and/or a combination of software and hardware used to operate, or simulate the operation of various potential embodiments.

It should also be understood that the apparatus and systems of various embodiments can be used in applications other than viewer identification, and thus, various embodiments are not to be so limited. The illustration of an apparatus 100 and systems 110 is intended to provide a general understanding of the structure of various embodiments, and not intended to serve as a complete description of all the elements and features of apparatus and systems that might make use of the structures described herein. Such apparatus and systems may further be included as sub-components within a variety of electronic systems and processes, including local area networks (LANs) and wide area networks (WANs), among others. Some embodiments may include a number of methods.

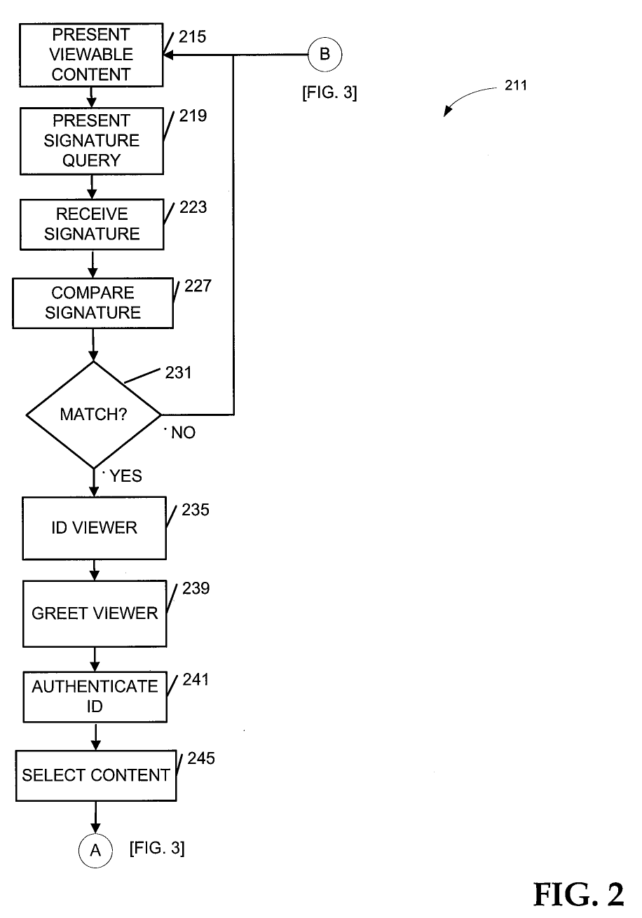

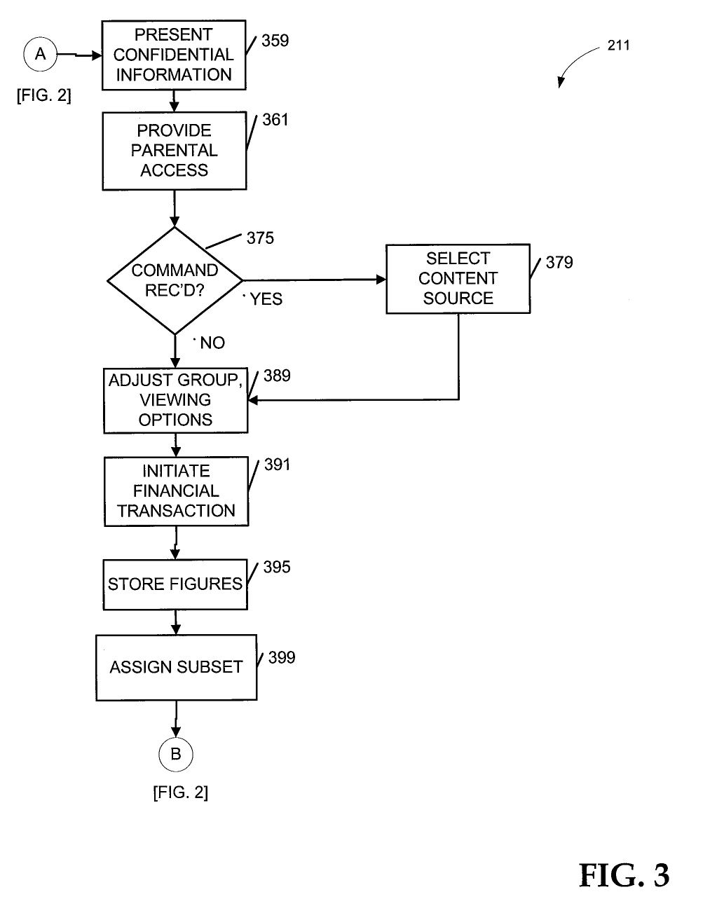

For example, FIGS. 2 and 3 are flow diagrams illustrating methods 211 according to various embodiments of the invention. The methods 211 may be performed by processing logic comprising hardware (e.g., dedicated logic, programmable logic, microcode, etc.), software (as run on a general purpose computer system or a dedicated machine), or a combination of both. It is to be noted that in some embodiments the processing logic may reside in any of the modules shown in FIG. 1.

Turning now to FIG. 2, it can be seen that a computer-implemented method 211 of identifying a television viewer (or other viewer of viewable content) includes presenting viewable content to the viewer on a display screen at block 215. The method 211 may continue with presenting a query for a transmitted signature on the display screen at block 219, and receiving the transmitted signature from a UID associated with the display screen at block 223. In most embodiments, the signature results from one or more gestures initiated by the viewer and detected by the UID. The gestures may comprise a series of substantially geometric shapes in some cases.

Receiving the transmitted signature at block 223 may comprise receiving a signal responsive to spatial or other manipulation of the UID. As noted above, the UID may comprise one or more accelerometers and/or one or more touch surfaces, including a multi-touch surface, among other elements, such as an infra-red control (e.g., used to directly select channels of viewable content). In some embodiments, receiving the transmitted signature at block 223 may occur without prompting the viewer.

The method 211 may continue with comparing the transmitted signature to a stored signature associated with a known individual at block 227 to determine whether an identity associated with the viewer matches an identity associated with the known individual at block 231.

If it is determined at block 231 that the transmitted signature does not substantially match the stored signature, then the method 211 may include retaining the viewable content and viewing options in response to this determination. In other words, when a transmitted signature does not substantially match a stored signature (e.g., fraudulent or simply incorrect gesture entry), some embodiments may operate to preserve the status quo, leaving the current viewable content and viewing options unchanged.

Upon determining that a transmitted signature substantially matching a stored signature has been received at block 231, many different actions based on identifying the viewer may occur. For example, the method 211 may include identifying the viewer as having household membership at block 235.

The method 211 may also include greeting the viewer by one or more of a name, an avatar, an icon, or an emoticon at block 239 based on the transmitted signature. The method 211 may further include authenticating the identity of the viewer based on the transmitted signature at block 241.

The method 211 may go on to selecting the viewable content at block 245 according to preferences associated with the known individual upon determining that the transmitted signature substantially matches the stored signature. Thus, viewable content that is selected for presentation can be displayed as a set of options (e.g., a list of viewable content, in menu format) based on the preferences and profile of the known viewer.

Turning now to FIG. 3, it can be seen that some embodiments of the method 211 include presenting confidential information associated with the known individual on the display screen at block 359. Confidential information may comprise financial information, user profile information, etc. The method 211 may go on to comprise providing access to parental viewing controls and/or parentally controlled content at block 361 upon determining that the transmitted signature substantially matches the stored signature (with or without authentication, as desired).

At block 375, the method 211 may include determining whether a command has been received from the UID. For example, upon receiving a command from the UID operating as a control, the method 211 may include selecting, at block 379, viewable content from a group consisting of a currently playing broadcast source, a video on demand source, a local content repository, a local network source, and the Internet. This mode of operation may involve the use of a UID that operates to detect gestures, as well as to select the source of viewable content. Such a device might include a wand with an accelerometer, as well as a keypad to make content selections.

In some embodiments, responsive to the identity associated with the viewer and the transmitted signature, the method 211 may include at block 389 either adding or subtracting the known individual to or from a group of known and previously identified individuals to modify membership of the group, and perhaps adjusting viewing options associated with the viewable content based on the modified membership.

The method 211 may go on to include initiating a financial transaction at block 391 upon determining that the transmitted signature substantially matches the stored signature. In some embodiments, the method 211 may include storing a set of substantially geometric figures at block 395, and assigning a subset of the set (of stored figures) to an individual member of a household at block 399 for later use as the transmitted signature. Thus, a signature might result from executing gestures indicating a fixed set of geometric figures, assigned to one or more household members.

It should be noted that the methods described herein do not have to be executed in the order described, or in any particular order. Thus, various activities described with respect to the methods identified herein can be executed in repetitive, simultaneous, serial, or parallel fashion. Information, including parameters, commands, instructions, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well known to those of ordinary skill in the art, such as application program interfaces or interprocess communication techniques, including remote procedure calls. The teachings of various embodiments are not limited to any particular programming language or environment, including hypertext markup language (HTML) and extensible markup language (XML).

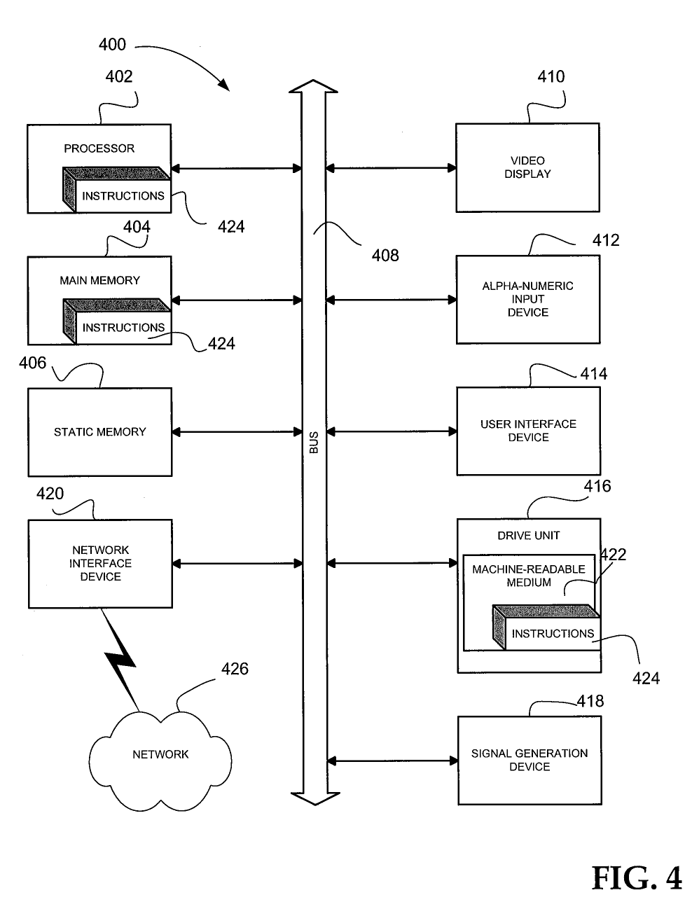

Thus, other embodiments may be realized. For example, FIG. 4 is a block diagram of a machine in the example form of a computer system 400 within which a set of instructions 424, to cause the machine to perform any one or more of the methodologies discussed herein, may be stored and/or executed.

In some embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment.

The machine may comprise a personal computer (PC), a tablet PC, a set-top box (STB), a Personal Digital Assistant (PDA), a cellular telephone, a web appliance, a network router, switch or bridge, or any machine capable of executing a set of instructions 424 (sequential or otherwise) that specify actions to be taken by that machine. Further, while only a single machine is illustrated, the term “machine” shall also be taken to include any collection of machines that individually or jointly execute a set (or multiple sets) of instructions 424 to perform any one or more of the methodologies discussed herein.

The example computer system 400 includes one or more processors 402 (e.g., a central processing unit (CPU), a graphics processing unit (GPU), a multi-core processor, or some combination of these), a main memory 404, and a static memory 406, which communicate with each other using a bus 408. The computer system 400 may further include a video display unit 410 (e.g., a liquid crystal display (LCD) or a cathode ray tube (CRT)). The computer system 400 also includes an alphanumeric input device 412 (e.g., a real or virtual keyboard), a UID 414, a disk drive unit 416, a signal generation device 418 (e.g., a speaker) and a network interface device 420. The display 410 may be similar or identical to the display 112 of FIG. 1. The UID 414 may be similar to or identical to the UID 126 of FIG. 1.

The disk drive unit 416 includes a machine-readable medium 422 on which is stored one or more sets of instructions 424 (e.g., software and/or data structures) embodying or utilized by any one or more of the methodologies or functions described herein. The instructions 424 may also reside, completely or at least partially, within the main memory 404 and/or within the processor 402 during execution thereof by the computer system 400. Thus, the main memory 404 and the processor 402 may also constitute machine-readable media.

The instructions 424 may further be transmitted or received over a network 426 via the network interface device 420 utilizing any one of a number of well-known transfer protocols (e.g., hyper-text transfer protocol).

While the machine-readable medium 422 is shown in an example embodiment to be a single medium, the term “machine-readable medium” may be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of various embodiments of the present invention, or that is capable of storing, encoding or carrying data structures utilized by or associated with such a set of instructions. The term “machine-readable medium” shall accordingly be taken to include, but not be limited to, various tangible storage devices, including solid-state memories, optical, and magnetic media. The embodiments described herein may be implemented in an operating environment comprising software installed on a computer, in hardware, or in a combination of software and hardware.

The medium 422 and memory 404, processor 402, and instructions 424 may be similar to or identical to the storage module 154, processor 158, and instructions 162 of FIG. 1, respectively. Thus, in some embodiments, a machine-readable medium 422 may comprise instructions 424, which when executed by one or more processors 402, perform operations that include presenting viewable content to a viewer on a display screen 410, receiving a transmitted signature from a UID 414 associated with the display screen 410 (wherein the signature results from at least one gesture initiated by the viewer and detected by the UID 414), and comparing the transmitted signature to a stored signature associated with a known individual to determine whether an identity associated with the viewer matches an identity associated with the known individual.

Additional operations may include determining the transmitted signature does not substantially match the stored signature, and retaining the viewable content and viewing options in response to this determination. Further operations may include storing a set of substantially geometric figures, assigning a subset of the set to an individual member of a household for later use as the transmitted signature, and any of the other elements of the methods described herein.

Implementing the apparatus, systems, and methods according to various embodiments may operate to remove barriers to, and increase the adoption of viewer identification and authentication for access to viewable content. Viewing activity may thus be made more rewarding, and an increase in transactional activity associated with viewable content may result.

The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method, comprising:
presenting viewable content to a viewer on a display screen;
receiving a transmitted signature from a user interface device (UID) associated with the display screen, wherein the signature results from at least one gesture initiated by the viewer and detected by the UID; and
comparing the transmitted signature to a stored signature associated with a known individual to determine whether an identity associated with the viewer matches an identity associated with the known individual.

2. The method of claim 1, wherein receiving the transmitted signature comprises:
receiving a signal responsive to spatial manipulation of the UID comprising at least one accelerometer.

3. The method of claim 1, wherein receiving the transmitted signature comprises:
receiving a signal responsive to manipulation of the UID comprising a touch surface.

4. The method of claim 1, comprising:
upon receiving a command from the UID operating as a control, selecting viewable content from a group consisting of a currently playing broadcast source, a video on demand source, a local content repository, a local network source, and the Internet.

5. The method of claim 1, wherein the UID comprises an infrared remote control.

6. The method of claim 1, comprising:
presenting a query for the transmitted signature on the display screen; and
upon receiving the transmitted signature that substantially matches the stored signature, presenting confidential information associated with the known individual on the display screen.

7. The method of claim 1, wherein the at least one gesture comprises a series of substantially geometric shapes.

8. The method of claim 1, comprising:
responsive to the identity associated with the viewer and the transmitted signature, either adding or subtracting the known individual to or from a group of known and previously identified individuals to modify membership of the group; and
adjusting viewing options associated with the viewable content based on the membership.

9. The method of claim 1, wherein the receiving occurs without prompting the viewer.

10. The method of claim 1, comprising:
initiating a financial transaction upon determining that the transmitted signature substantially matches the stored signature.

11. The method of claim 1, comprising:
selecting the viewable content according to preferences associated with the known individual upon determining that the transmitted signature substantially matches the stored signature.

12. The method of claim 1, comprising:
greeting the viewer by at least one of a name, an avatar, an icon, or an emoticon upon determining that the transmitted signature substantially matches the stored signature.

13. The method of claim 1, comprising:
identifying the viewer as having household membership based on the transmitted signature.

14. The method of claim 1, comprising:
authenticating the identity of the viewer based on the transmitted signature.

15. The method of claim 1, comprising:
providing access to at least one of parental viewing controls or parentally controlled content upon determining that the transmitted signature substantially matches the stored signature.

16. An apparatus, comprising:
a content reception module to receive viewable content;
a display screen to display the viewable content;
a signature reception module to receive a transmitted signature resulting from at least one gesture initiated by the viewer and detected by a user interface device associated with the display screen; and
a comparison module to compare the transmitted signature to a stored signature associated with a known individual to determine whether an identity associated with the viewer matches an identity associated with the known individual.

17. The apparatus of claim 16, wherein the display screen comprises a television screen.

18. The apparatus of claim 16, comprising:
a storage module to store a plurality of user signatures including the stored signature, and a corresponding plurality of user profiles.

19. A system, comprising:
a content reception module to receive viewable content;
a display screen to display the viewable content;
a user interface device (UID) to control the display screen and to transmit a transmitted signature resulting from at least one gesture initiated by the viewer and detected by the UID; and
a comparison module to compare the transmitted signature to a stored signature associated with a known individual to determine whether an identity associated with the viewer matches an identity associated with the known individual.

20. The system of claim 19, wherein the UID comprises a remote control wand having at least one accelerometer.

21. The system of claim 19, wherein the UID comprises a touch surface forming part of the display screen.

22. The system of claim 19, wherein the UID comprise a body displacement sensor.

23. A machine-readable medium comprising instructions, which when executed by one or more processors, perform the following operations:
presenting viewable content to a viewer on a display screen;
receiving a transmitted signature from a user interface device (UID) associated with the display screen, wherein the signature results from at least one gesture initiated by the viewer and detected by the UID; and
comparing the transmitted signature to a stored signature associated with a known individual to determine whether an identity associated with the viewer matches an identity associated with the known individual.

24. The medium of claim 23, comprising instructions, which when executed by the one or more processors, perform the following operations:
determining the transmitted signature does not substantially match the stored signature; and
retaining the viewable content and viewing options in response to the determining.

25. The medium of claim 23, comprising instructions, which when executed by the one or more processors, perform the following operations:
storing a set of substantially geometric figures; and
assigning a subset of the set to an individual member of a household for later use as the transmitted signature.
